(19) United States
(12) Patent Application Publication
(10) Pub. No.: US 2026/0322255 A1
(43) Pub. Date: Oct. 15, 2026

(54) CONVERTER ARRANGEMENT AND METHOD FOR THE OPERATION THEREOF

(71) Applicant: Siemens Energy Global GmbH & Co. KG, München (DE)

(72) Inventors: Michael Leicht, Schlüsselfeld (DE); Jonas Pinkwart, Fürth (DE); Sascha Roman Müller, Dresden (DE); Martin Pieschel, Altdorf (DE)

(21) Appl. No.: 19/648,155

(22) Filed: Apr. 15, 2026

(30) Foreign Application Priority Data
Apr. 15, 2025 (EP) 25170674

(51) Int. Cl. H02M 1/36; H02M 1/00; H02M 5/293

(52) U.S. Cl. CPC H02M 1/36; H02M 1/0067; H02M 5/2932

(57) ABSTRACT

A converter arrangement has a modular matrix converter with switching modules which each have power semiconductor switches and an energy store, and which is connected on the grid side to an at least three-phase AC voltage connection. A precharging device for precharging the energy stores is provided. The precharging device contains a precharging module which is connected on the grid side to exactly two phase lines of the AC voltage connection and on the load side to a first output of the matrix converter, and which comprises switching elements, by which the two phase lines are each able to be connected to the first output of the matrix converter. A method operates the converter arrangement by precharging the energy stores.

### CROSS-REFERENCE TO RELATED APPLICATION

This application claims the priority, under 35 U.S.C. § 119, of European Patent Application EP 25170674.3, filed Apr. 15, 2025; the prior application is herewith incorporated by reference in its entirety.

### FIELD AND BACKGROUND OF THE INVENTION

The invention relates to a converter arrangement having a modular matrix converter, wherein the matrix converter contains switching modules which each have power semiconductor switches and an energy store belonging to each switching module, and which, during operation, is connected on the grid side to an at least three-phase AC voltage connection.

Such a converter arrangement can be used, for example, to supply power to a non-linear load. An example of a non-linear load is an electric arc furnace (EAF), by means of which, for example for steel production, conductive material can be heated to temperatures of up to 4,000° C. and melted. The multi-phase AC voltage connection can be part of an AC voltage grid or be connected to such a grid.

European patent EP 3 120 451 B1, corresponding to U.S. patent No. 10,470,259, discloses a power supply device for a non-linear load, which device has a modular matrix converter.

During start-up, the energy stores of the switching modules of the matrix converter have to be charged (precharged) (in this case, start-up is understood to mean both a first start-up after installation and in the sense of switching on after an interruption in operation). This can be carried out by means of an external auxiliary power supply, but this considerably increases the complexity and the costs of the converter arrangement. It is also known to provide the necessary voltage (typically approximately 70% above a nominal voltage of the AC voltage connection) by means of a transformer device. However, this solution leads to problems with insulation requirements, a large space requirement, installation costs and operating costs. Furthermore, an additional risk to persons is possible in this case.

European patent EP 3 269 033 B1 discloses using an arrangement of mechanical switching elements to temporarily change three star-connected converter elements over into a delta connection of the converter elements. These are passively precharged with a nominal voltage. This disadvantageously results in a high installation outlay because of the necessary connection management. In addition, the coordination of the switching elements is susceptible to errors, and a high number of switching elements have to be serviced.

### SUMMARY OF THE INVENTION

The object of the invention is to propose a converter arrangement mentioned at the outset, which is as cost-effective and reliable as possible during operation, in particular with regard to the start-up thereof and precharging of the energy stores.

The object is achieved by a converter arrangement having a modular matrix converter. The matrix converter contains switching modules which each have power semiconductor switches and an energy store, and which is connected on the grid side to an at least three-phase AC voltage connection.

The converter arrangement according to the invention is accordingly distinguished by a precharging device for precharging the energy stores. The precharging device contains at least one precharging module which is connected on the grid side to exactly two phase lines of the AC voltage connection and on the load side to a first output of the matrix converter, and which contains switching elements, by means of which the two phase lines - independently of one another - are each able to be connected to (or able to be disconnected from) the first output of the matrix converter.

With the invention, it is possible to use an arrangement of mechanical switching elements to precharge the matrix converter, which arrangement has simple connection management with relatively few switching elements and which in addition is relatively simple to control. The energy stores of the matrix converter are supplied with a phase-to-phase grid voltage in a targeted manner by virtue of the precharging module being changed over. The individual converter units can be bridged in a suitably targeted manner and charged with the phase-to-phase grid voltage in a subsequent step. Surprisingly, it has been shown that connecting to only two phases of the AC voltage connection is sufficient, this in turn making it possible to expediently use two switching elements. Three switching elements for connecting all the (usually three) grid voltage phases are not necessary.

The present solution offers several advantages over the known solutions: There is no need for a complex transformer circuit; relatively few disconnect switches and/or circuit breakers are required; and the solution requires a small space requirement. In addition, the wiring is relatively small, this advantageously reduces the installation outlay.

According to one embodiment, the precharging device further contains a changeover device, by means of which the first output of the matrix converter (or the output of the precharging module) is able to be connected to a second and to a third output of the matrix converter. The changeover device suitably has an input and two outputs. The input is connected to a first output by means of a first changeover switch and to a second output by means of a second changeover switch. The input of the changeover device can be connected to an output of the precharging module. The first output of the changeover module can be connected to the second output of the matrix converter and the second output of the changeover module can be connected to the third output of the matrix converter. If the first changeover switch is open, the input of the changeover device is electrically disconnected from its first output, and if the second changeover switch is open, the input of the changeover device is electrically disconnected from its second output. With the switching elements of the precharging module and the changeover switches of the changeover device, this variant has a particularly small number of necessary switches.

Expediently, the at least one precharging module is a first precharging module, wherein the precharging device further contains a second precharging module which is connected on the grid side (directly) to exactly two phase lines of the AC voltage connection and on the load side to a second output of the matrix converter, and which comprises switching elements, by means of which the two phase lines (independently of one another) are each able to be connected to the second output of the matrix converter. For example, a first input of the first precharging module is directly connected to a first phase line and a second input of the first precharging module is connected to a second phase line. A first input of the second precharging module can be connected to the first phase line, but also to any other phase line. If the first input of the second precharging module is connected to the second phase line, for example, a second input of the second precharging module can be connected to the first or to the third phase line. With this variant, the outputs of the matrix converter can each be connected to (or disconnected from) the AC voltage connection by means of a precharging module assigned to them.

Preferably, the at least one precharging module contains a first precharging branch, which connects a first phase line of the AC voltage connection to the first output of the matrix converter, and in which a first switching element is arranged, and a second precharging branch, which connects a second phase line of the AC voltage connection to the first output of the matrix converter, and in which a second switching element is arranged. The two precharging branches can be connected to one another on the output side (on the matrix converter side) and assigned to a common output of the precharging module. If a plurality of precharging modules are used, some or all of the precharging modules can be constructed in the same way. In this way, particularly simple implementation of the precharging module is provided.

The at least one switching element (for example the first and/or the second switching element) of the at least one precharging module is suitably a circuit breaker. Circuit breakers have the advantage of being able to switch particularly quickly (typically in the region of 100 ms).

The at least one switching element of the at least one precharging module (for example the first and/or the second switching element) can be a disconnect switch. Although disconnect switches usually have switching times of more than 1 s, they have a simpler construction and are generally less expensive than circuit breakers.

Preferably, the at least one precharging module contains resistor elements for peak current limitation. By way of example, each resistor element can be arranged in series with at least one switching element of the precharging module. For example, a first resistor element can be arranged in the first precharging branch. Alternatively or in addition, a second resistor element can be arranged in the second precharging branch. It is likewise possible to arrange a resistor element between a connection point of the precharging branches and the output of the precharging module. Expediently, an operating current always flows through the precharging module through at least one resistor element, irrespective of the switching state of the switching elements of the precharging module. Expediently, a resistor element is connected in series with each of the switching elements of the at least one precharging module.

Preferably, a resistance value of the resistor elements is in each case between 10 ohms and 100 ohms. In this way, effective protection against overcurrents is ensured in the case of high-voltage applications and an operating current of more than 1 kA.

According to one embodiment of the invention, the precharging device further contains a precharging resistor circuit. The precharging resistor circuit has resistor elements which are each arranged in one phase line of the AC voltage connection and are able to be bridged by means of at least one bridging switching element. The precharging resistor circuit can be arranged on the grid side or input side of the matrix converter. The precharging resistor circuit can be of multi-phase design (corresponding to the number of phase lines of the AC voltage connection, for example three-phase). During the precharging, the associated bridging switching elements (for example mechanical switching elements) are open; after the precharging, they are closed. This advantageously prevents the occurrence of extremely high current peaks in all converter units. Such high current peaks can damage the switching modules.

Suitably, the matrix converter has a plurality of converter units. The converter units each have a plurality of main modules. The main modules each have an input connection which is connected in each case to one phase line of the AC voltage connection. The converter units each have a star point which is connected on one side to a respective output connection of the main modules of the respective converter unit and on the other side to one of the outputs of the matrix converter. The main modules each have a series connection of a coupling inductance and of a plurality of the switching modules. In a 3x3-phase design, the matrix converter contains nine main modules. A first main module extends between a first phase line and a first output of the matrix converter or a first star point of the matrix converter. A second main module extends between a second phase line and the first output of the matrix converter. A third main module extends between a third phase line and the first output of the matrix converter. A fourth main module extends between the first phase line and a second output of the matrix converter or a second star point of the matrix converter. A fifth main module extends between the second phase line and the second output of the matrix converter. A sixth main module extends between the third phase line and the second output of the matrix converter. A seventh main module extends between the first phase line and a third output of the matrix converter or a third star point of the matrix converter. An eighth main module extends between the second phase line and the third output of the matrix converter. A ninth main module extends between the third phase line and the third output of the matrix converter. The first star point is connected to the first output of the matrix converter. Correspondingly, the second star point is connected to the second output and the third star point is connected to the third output of the matrix converter.

The switching modules of the matrix converter are preferably full-bridge switching modules. The full-bridge switching modules each contain a first and a second switching module terminal as well as a bridge circuit between the switching module terminals having four self-commutated power semiconductor switches and a bridge branch, in which in each case an energy store, preferably in the form of a storage capacitor, is arranged. The power semiconductor switches of the switching modules are each able to be switched independently of the power semiconductor switches of the other switching modules of the matrix converter. The power semiconductor switches are preferably turn-off semiconductor switches such as IGBTs, IGCTs or other suitable semiconductor switching elements. They can have an integrated freewheeling diode.

Suitably, the number of switching modules in each main module is between 10 and 100. In this way, voltages of several hundred volts, in particular of above 10 kV, can be generated by means of the converter arrangement.

According to one embodiment of the invention, a first operating frequency at an input connection of the converter arrangement is lower than a second operating frequency at an output connection of the converter arrangement. The operating frequency on the input side expediently corresponds to the grid frequency of the supply grid (e.g. 50 Hz or 60 Hz). The operating frequency on the output side can be, for example, 70 Hz. The operating frequency on the output side can thus be adapted to suit the respective application, in particular the respective load to which power is to be supplied.

Preferably, the converter arrangement further contains a first connecting device, which is arranged on the input side of the matrix converter, and/or a second connecting device, which is arranged on the output side of the matrix converter. For the process of precharging, the matrix converter can be decoupled from the load by means of the connecting device (having mechanical switches) arranged on the output side (on the load side) of the matrix converter. For carrying out switching operations in the precharging device, the matrix converter and the precharging device can be decoupled from the grid by means of the connecting device on the input side (on the grid side).

The invention further relates to a method for operating a converter arrangement having a modular matrix converter.

The object of the invention is to specify such a method which is as reliable and cost-effective as possible, in particular with regard to precharging the matrix converter.

The object is achieved by a method having the features of the independent method claim.

To this end, the matrix converter contains switching modules which each have power semiconductor switches and an energy store belonging to each switching module, and is connected on the grid side to an at least three-phase AC voltage connection. The converter arrangement further contains a precharging device for precharging the energy stores of the matrix converter. The precharging device contains at least one precharging module which is connected on the grid side to exactly two phase lines of the AC voltage connection and on the load side to a first output of the matrix converter, and which comprises switching elements, by means of which the two phase lines are each able to be connected to the first output of the matrix converter. According to the invention, in order to precharge the energy stores, the matrix converter is connected on the load side sequentially (successively) to two (different) phase lines of the AC voltage connection by means of the precharging device.

For example, by virtue of a corresponding switching action by means of a switching element of the precharging module, the first output (output connection) of the matrix converter (or the first star point of the matrix converter) can first be connected to the first phase line of the AC voltage connection. As a result, the energy stores of those main modules of the matrix converter which extend between the first star point and the second and the third phase line can be charged. This connection is then disconnected and the first output of the matrix converter is connected to the second phase line, as a result of which the energy stores of the rest of the main module can be charged. Correspondingly, it is also possible to proceed with the energy stores of the other converter units.

The advantages of the method according to the invention emerge in particular from the advantages described already in connection with the converter arrangement according to the invention.

Other features which are considered as characteristic for the invention are set forth in the appended claims.

Although the invention is illustrated and described herein as embodied in a converter arrangement and a method for the operation thereof, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of a first exemplary embodiment of a converter arrangement according to the invention;

FIG. 2 is a schematic illustration of a second exemplary embodiment of the converter arrangement according to the invention;

FIG. 3 is a flowchart of an exemplary embodiment of a method according to the invention;

FIG. 4 is a schematic illustration of a third exemplary embodiment of the converter arrangement according to the invention;

FIG. 5 is a flowchart of a further exemplary embodiment of the method according to the invention;

FIG. 6 is a schematic illustration of a first exemplary embodiment of a precharging module;

FIG. 7 is a schematic illustration of a second exemplary embodiment of the precharging module;

FIG. 8 is a schematic illustration of a third exemplary embodiment of the precharging module;

FIG. 9 is a schematic illustration of an exemplary embodiment of a switching module; and

FIG. 10 is a schematic illustration of a further exemplary embodiment of the converter arrangement according to the invention.

### DETAILED DESCRIPTION OF THE INVENTION

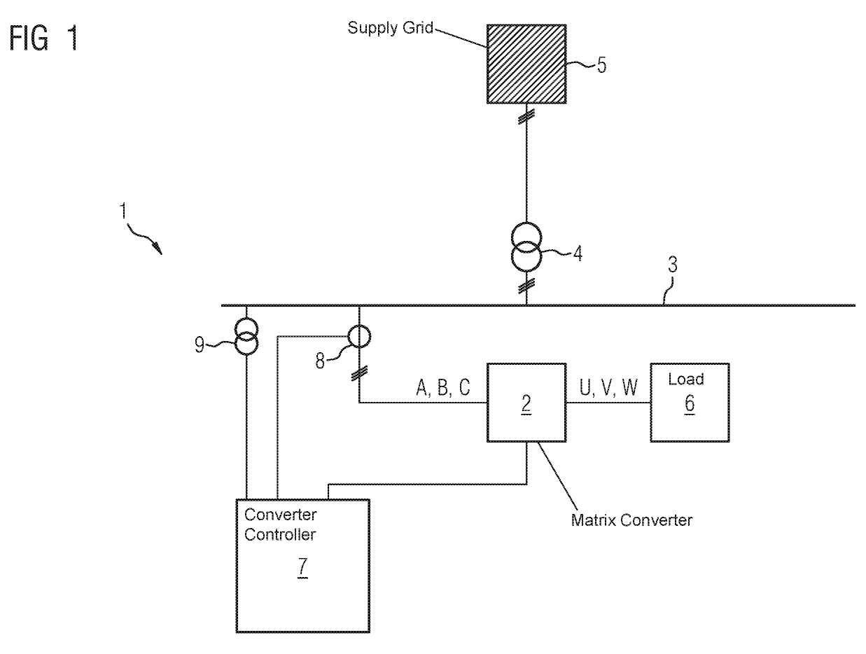

Referring now to the figures of the drawings in detail and first, particularly to FIG. 1 thereof, there is shown a converter arrangement 1 having a matrix converter 2. The matrix converter 2 is connected on the grid side (on the input side) to a three-phase AC voltage connection 3 by means of input connections A, B, C (provided by a connection rail in the example illustrated). The AC voltage connection 3 is connected to a supply grid 5 via a grid transformer 4. On the load side (on the output side), the matrix converter 2 is connected to a three-phase current load 6 (for example an electric arc furnace) by means of output-side connections U, V, W. In this case, a precharging device for precharging the matrix converter 2 is integrated into the matrix converter 2. The converter arrangement 1 further comprises a converter control unit 7 for controlling and adjusting the converter arrangement, for which purpose the converter control unit is connected in particular to a current measurement device 8 and to a voltage measurement device 9. During operation of the converter arrangement 1, the AC voltage connection 3 has an operating voltage of 30 kV (usually the operating voltage can in many cases be in the range of 10 kV - 40 kV) and a current of 2.5 kA.

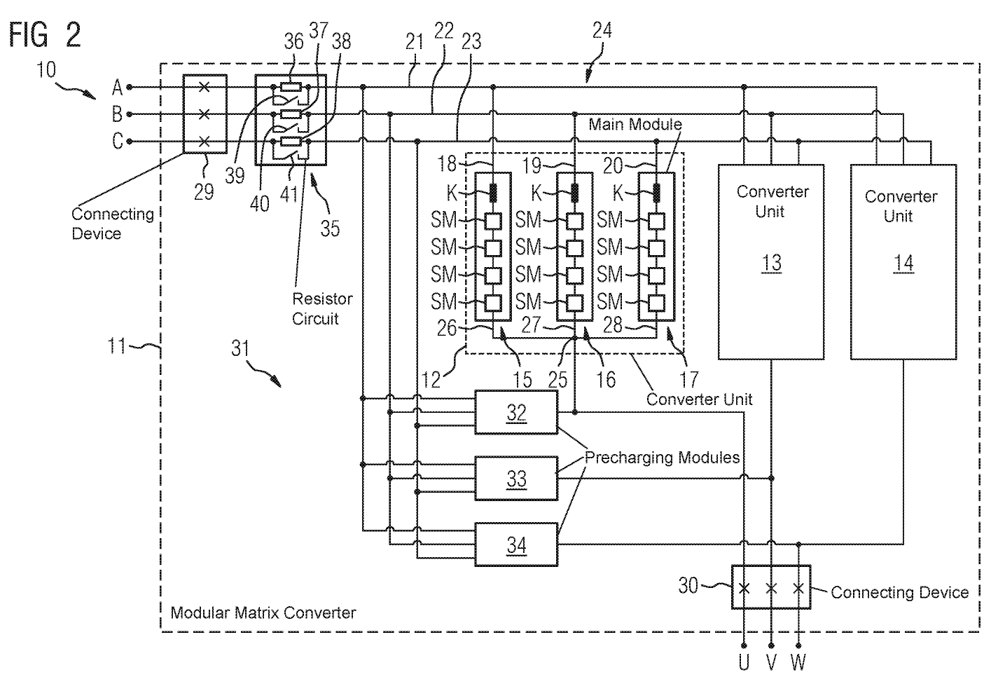

FIG. 2 shows a converter arrangement 10 having a modular matrix converter 11. The matrix converter 11 has a grid side having grid-side connections A, B, C which can connect the matrix converter 11 to an AC voltage connection. Furthermore, the matrix converter 11 has a load side having load-side connections U, V, W which can connect the matrix converter 11 to a load.

The matrix converter has three converter units 12, 13, 14 which are arranged between the grid-side and the load-side connections. A first converter unit 12 contains three main modules 15, 16, 17, wherein the main modules each have an input connection 18, 19, 20 which is respectively connected to a phase line 21, 22, 23 of the AC voltage connection 24. The first converter unit 12 has a first star point 25 which is connected on one side to a respective output connection 26, 27, 28 of the main modules of the first converter unit 12 and on the other side to a first output-side connection U of the matrix converter. The main modules 15, 16, 17 each comprise a series connection of a coupling inductance K and of a plurality of the switching modules SM. In the example illustrated in FIG. 2, the main modules 15-17 each have four switching modules SM, but the number thereof is in principle arbitrary and can be adapted to suit the respective application (in particular to suit the required voltage).

The second and third converter units 13, 14 are constructed in the same way as the first converter unit 12. The second converter unit 13 extends between the AC voltage connection 24 and a second output connection V, and the third converter unit 14 extends between the AC voltage connection 24 and a third output connection W.

The converter arrangement 10 further contains a first mechanical connecting device 29, which is arranged on the input side of the matrix converter, and a second mechanical connecting device 30, which is arranged on the output side of the matrix converter.

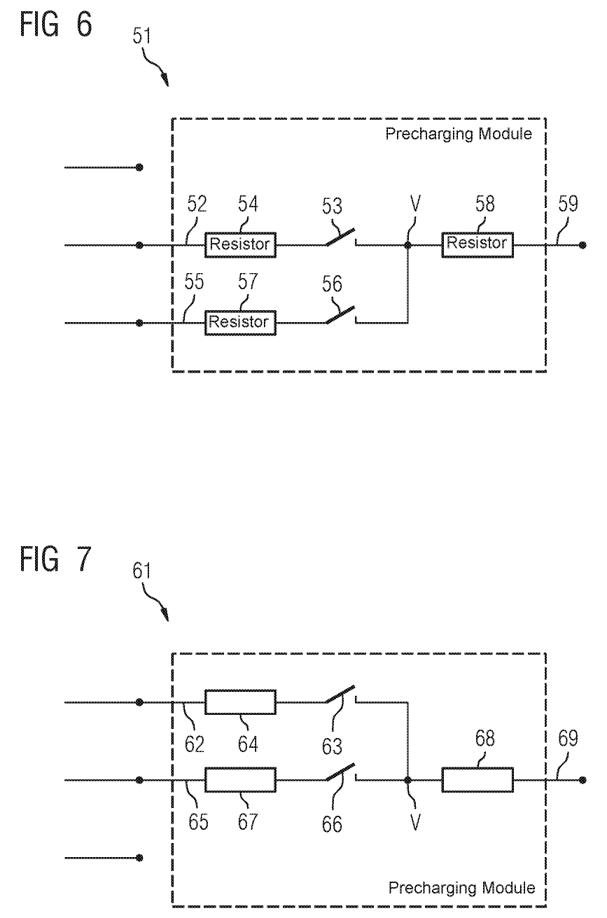

The converter arrangement 10 further contains a precharging device 31 for precharging the energy stores of the switching modules SM. The precharging device 31 contains three precharging modules 32, 33, 34. Although FIG. 2 graphically illustrates input-side connections of the precharging modules 32, 33, 34 to all three phase lines 21-23 of the AC voltage connection 24, each precharging module is connected to exactly two phase lines of the AC voltage connection in each case. This becomes clear from the illustrations in FIGS. 6-8, where the construction of the precharging modules 32-34 is discussed. The precharging modules 32-34 are connected on the load side to an output U, V and W, respectively, of the matrix converter.

The precharging device additionally contains a precharging resistor circuit 35. The precharging resistor circuit 35 has resistor elements 36, 37, 38 which are each arranged in one phase line 21-23 of the AC voltage connection 24 and are able to be bridged by means of a bridging switching element 39, 40, 41 respectively assigned to them.

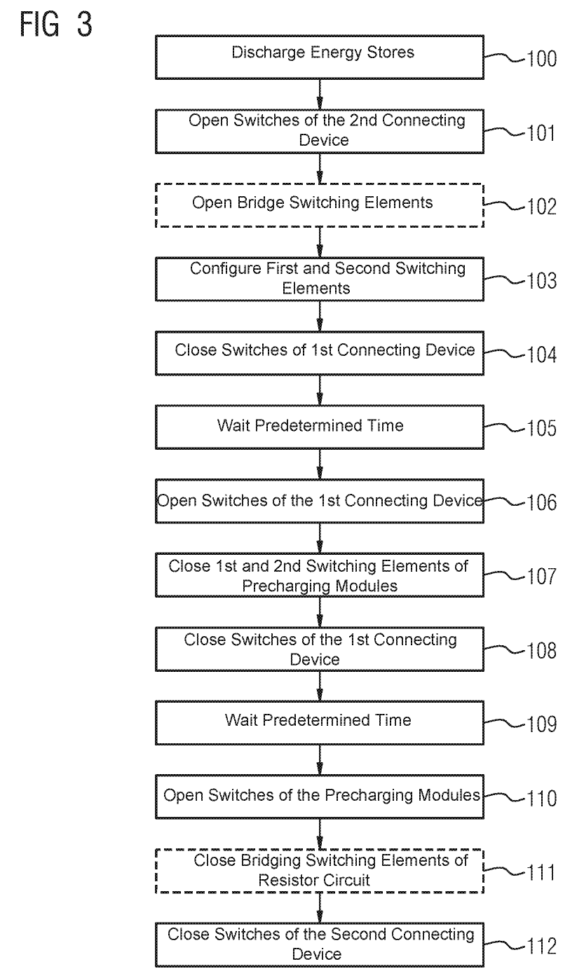

FIG. 3 shows a flowchart for a method for operating a converter arrangement (for example the converter arrangement 10 of FIG. 2). The sequence for precharging converter arrangement 10 during its start-up is illustrated.

In an initial state 100, the matrix converter 11, i.e. the energy stores C of the switching modules SM, is discharged.

In a first step 101, the switches of the second connecting device 30 are opened.

In a second step 102, the bridging switching elements 39-41 of the precharging resistor circuit 35 are opened.

In a third step 103, the first switching element 53, 63, 73 (cf. FIGS. 6-8) of the precharging modules 32-34 is closed in each case, and the second switching element 56, 66, 76 of the precharging modules 32-34 is (or remains) opened in each case.

In a fourth step 104, the switches of the first connecting device 29 are closed.

In a fifth step 105, there is a wait of a predetermined time, typically 10-60 seconds.

In a sixth step 106, the switches of the first connecting device 29 are opened. In one particular embodiment, in which the switching elements 53, 63, 73, 56, 66, 76 are embodied as circuit breakers, this step can be omitted. As a result, the switching time can be saved.

In a seventh step 107, the first switching element 53, 63, 73 (cf. FIGS. 6-8) of the precharging modules 32-34 is opened in each case, and the second switching element 56, 66, 76 of the precharging modules 32-34 is closed in each case.

In an eighth step 108, the switches of the first connecting device 29 are closed.

In a ninth step 109, there is a wait of a predetermined time, typically 10-60 seconds.

In a tenth step 110, all the switching elements of the precharging modules are opened.

In an eleventh step 111, the bridging switching elements 39-41 of the precharging resistor circuit 35 are closed.

In a twelfth step 112, the switches of the second connecting device 30 are closed.

Three of the nine main modules of the matrix converter can be charged or recharged multiple times in the method described above.

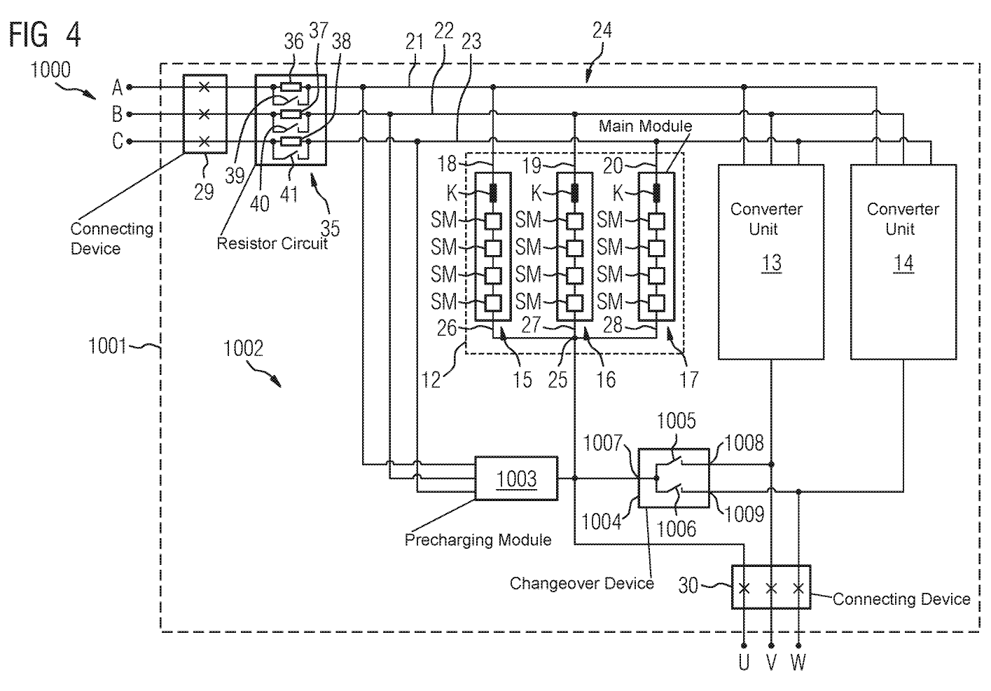

FIG. 4 shows a converter arrangement 1000 having a modular matrix converter 1001. Identical and similar elements of the converter arrangement 1 of FIG. 1 and of the converter arrangement 1000 are provided with the same reference signs. For reasons of clarity, only differences between the converter arrangement 1 and the converter arrangement 1000 will be discussed in more detail below.

The converter arrangement 1000 comprises a precharging device 1002 having a precharging module 1003 and a changeover device 1004. The precharging module 1003 can be constructed in the same way as one of the precharging modules 51, 61, 71 shown in FIGS. 6-8.

By means of the changeover device 1004, the first output of the matrix converter can be connected to a second and to a third output of the matrix converter. The changeover device 1004 has an input 1007 and two outputs 1008, 1009. The input 1007 is connected to the first output 1008 by means of a first changeover switch 1005 and to a second output 1009 by means of a second changeover switch 1006. The first output 1008 of the changeover module 1004 is connected to the second output V of the matrix converter and the second output 1009 of the changeover module 1004 is connected to the third output W of the matrix converter.

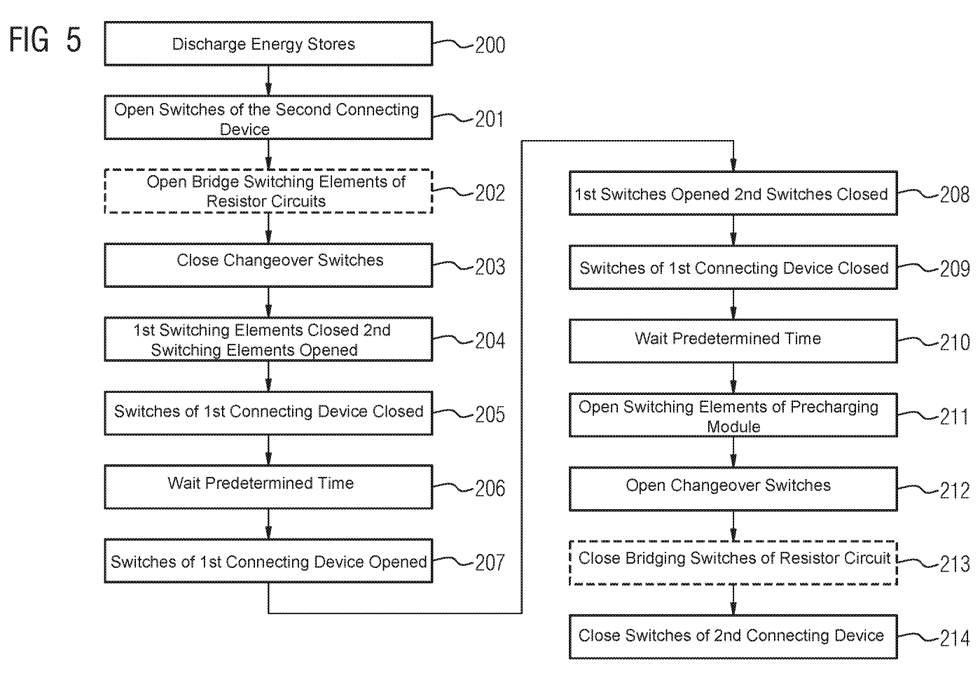

FIG. 5 shows a flowchart for a method for operating a converter arrangement (for example the converter arrangement 1000 of FIG. 4). The sequence for precharging converter arrangement 1000 during its start-up is illustrated.

In an initial state 200, the matrix converter 11, i.e. the energy stores C of the switching modules SM, is discharged.

In a first step 201, the switches of the second connecting device 30 are opened.

In a second step 202, the bridging switching elements 39-41 of the precharging resistor circuit 35 are opened.

In a third step 203, the changeover switches 1005, 1006 of the changeover device 1004 are closed.

In a fourth step 204, the first switching element 53, 63, 73 (cf. FIGS. 6-8) of the precharging module 1003 is closed, and the second switching element 56, 66, 76 of the precharging module 1003 is (or remains) opened.

In a fifth step 205, the switches of the first connecting device 29 are closed.

In a sixth step 206, there is a wait of a predetermined time, typically 10-60 seconds.

In a seventh step 207, the switches of the first connecting device 29 are opened. In one particular embodiment, in which the switching elements 53, 63, 73, 56, 66, 76 are embodied as circuit breakers, this step can be omitted. As a result, the switching time can be saved.

In an eighth step 208, the first switching element 53, 63, 73 (cf. FIGS. 6-8) of the precharging module 1003 are opened, and the second switching element 56, 66, 76 of the precharging module 1003 is closed.

In a ninth step 209, the switches of the first connecting device 29 are closed.

In a tenth step 210, there is a wait of a predetermined time, typically 10-60 seconds.

In an eleventh step 211, both switching elements of the precharging module are opened.

In a twelfth step 212, the changeover switches 1005, 1006 of the changeover device 1004 are opened.

In a thirteenth step 213, the bridging switching elements 39-41 of the precharging resistor circuit 35 are closed.

In a fourteenth step 214, the switches of the second connecting device 30 are closed.

Three of the nine main modules of the matrix converter can be charged or recharged multiple times in the method described above.

FIG. 6 shows a precharging module 51 which is suitable for the converter arrangements of FIGS. 2 and 4 or the precharging devices thereof. The precharging module 51 comprises a first precharging branch 52 which connects the second phase line 22 of the AC voltage connection 24 (cf. FIG. 2) to an output U, V or W of the matrix converter. A first switching element 53 (a circuit breaker or a disconnect switch) is arranged in the first precharging branch 52. A first resistor element 54 is arranged in series with the first switching element 53. The precharging module additionally comprises a second precharging branch 55, which connects the third phase line 23 of the AC voltage connection 24 to the output of the matrix converter, and in which a second switching element 56 and a second resistor element 57 are arranged. A third resistor element 58 is furthermore arranged between a connection point V of the two precharging branches 52, 55 and an output 59 of the precharging module 51. In the example illustrated here, the resistor elements 54, 57, 58 each have a resistance value of 70 ohms. In general, the magnitude of the resistance value primarily depends on the available voltage (nominal voltage of the grid) and on the maximum permissible current at the start of the precharging.

For the examples illustrated in the figures, it should also be noted that, if the precharging circuit 35 is present, the resistor elements in the precharging modules are not necessary. If the precharging circuit 35 is not present, not all three resistor elements have to be present. However, at least one resistor element per parallel branch is then needed. That is to say, e.g., either at least 58 or at least 54 and 57.

FIG. 7 shows a precharging module 61 which is suitable for the converter arrangements of FIGS. 2 and 4 or the precharging devices thereof. The precharging module 61 comprises a first precharging branch 62 which connects the first phase line 21 of the AC voltage connection 24 (cf. FIG. 2) to an output U, V or W of the matrix converter. A first switching element 63 (a circuit breaker or a disconnect switch) is arranged in the first precharging branch 62. A first resistor element 64 is arranged in series with the first switching element 63. The precharging module additionally comprises a second precharging branch 65, which connects the second phase line 22 of the AC voltage connection 24 to the output of the matrix converter, and in which a second switching element 66 and a second resistor element 67 are arranged. A third resistor element 68 is furthermore arranged between a connection point V of the two precharging branches 62, 65 and an output 69 of the precharging module 61. The resistor elements 64, 67, 68 each have a resistance value of 70 ohms.

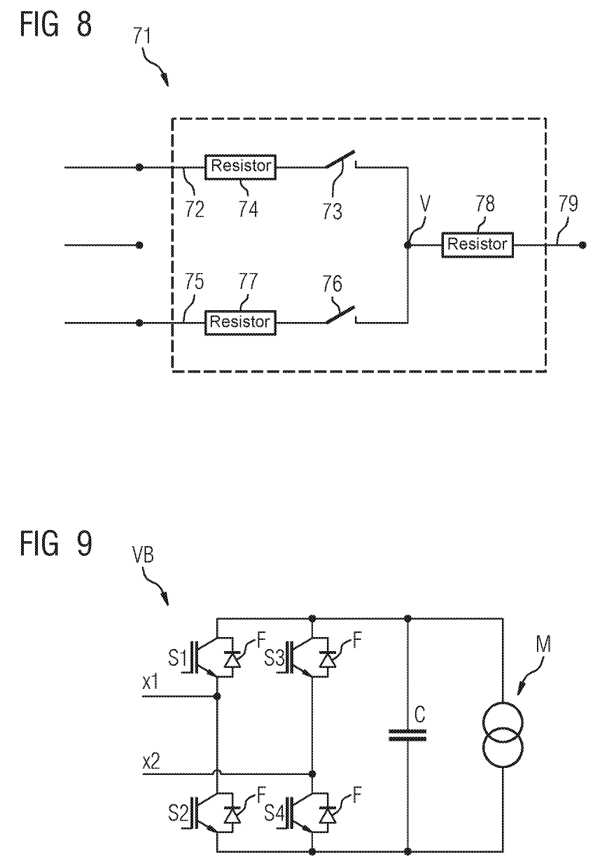

FIG. 8 shows a precharging module 71 which is suitable for the converter arrangements of FIGS. 2 and 4 or the precharging devices thereof. The precharging module 71 comprises a first precharging branch 72 which connects the first phase line 21 of the AC voltage connection 24 (cf. FIG. 2) to an output U, V or W of the matrix converter. A first switching element 73 (a circuit breaker or a disconnect switch) is arranged in the first precharging branch 72. A first resistor element 74 is arranged in series with the first switching element 73. The precharging module additionally comprises a second precharging branch 75, which connects the third phase line 23 of the AC voltage connection 24 to the output of the matrix converter, and in which a second switching element 76 and a second resistor element 77 are arranged. A third resistor element 78 is furthermore arranged between a connection point V of the two precharging branches 72, 75 and an output 79 of the precharging module 71. The resistor elements 74, 77, 78 each have a resistance value of 70 ohms.

FIG. 9 shows a full-bridge switching module VB. The full-bridge switching module VB contains in each case a first and a second switching module terminal X1, X2 as well as a bridge circuit between the switching module terminals X1, X2 having four self-commutated (turn-off) power semiconductor switches S1-S4, each of which has a freewheeling diode F connected in antiparallel, and a bridge branch, in which an energy store in the form of a storage capacitor C is arranged. The power semiconductor switches S1-S4 are preferably turn-off semiconductor switches such as IGBTs, IGCTs or other suitable semiconductor switching elements. A voltage measurement device M is arranged in parallel with the storage capacitor C.

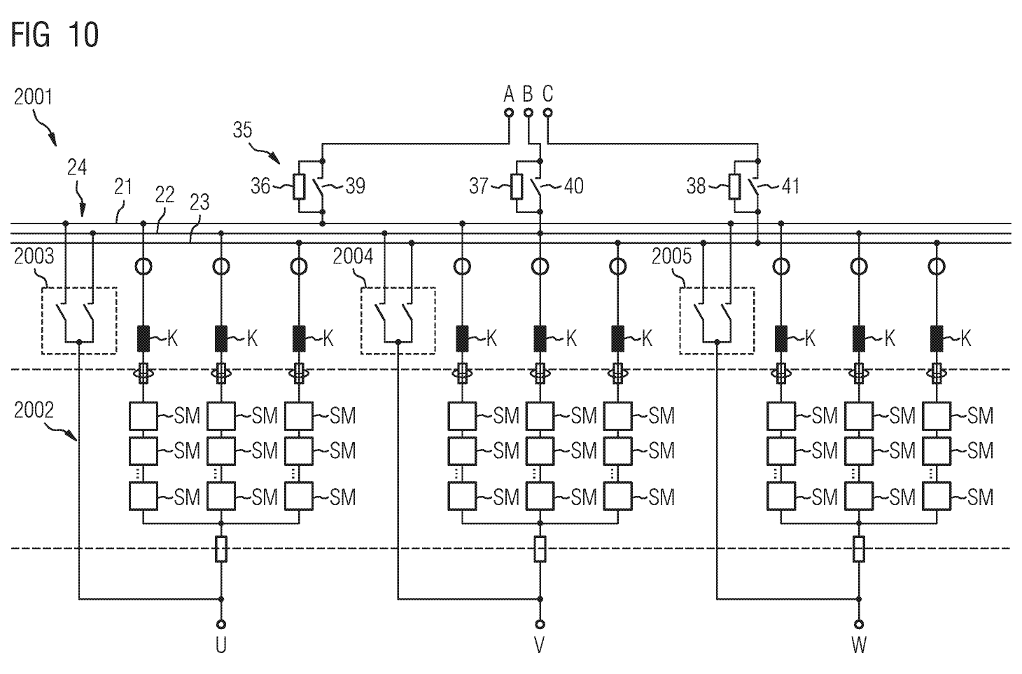

A further converter arrangement 2001 having a matrix converter 2002 is shown in FIG. 10. For reasons of clarity, the same parts and components of FIGS. 2 and 10 are provided with the same reference signs. Similarly to the embodiment of FIG. 2, the precharging device of the converter arrangement 2001 also comprises a precharging resistor circuit 35. The precharging device further comprises a first, a second and a third precharging module 2003, 2004, 2005. A first and a second phase line 21, 22 of an AC voltage connection 24 are able to be connected to a first output U of the matrix converter 2002 by means of the first precharging module 2003. The second and a third phase line 22, 23 are able to be connected to a second output V of the matrix converter 2002 by means of the second precharging module 2004. The third and the first phase line 23, 21 are able to be connected to a third output W of the matrix converter 2002 by means of the third precharging module 2005. According to this example, the precharging modules 2003-2005 have no resistor elements. In this case, the current peaks can be limited by means of the resistors 36, 37 and 38.

1. A converter arrangement, comprising:
a modular matrix converter, containing:
a first output;
switching modules each having power semiconductor switches and an energy store, and said switching modules being connectable on a grid side to an at least three-phase AC voltage connection; and
a precharging device for precharging energy stores, said precharging device having at least one precharging module connected on the grid side to exactly two phase lines of the three-phase AC voltage connection and on a load side to a first output of said modular matrix converter, said at least one precharging module having switching elements, by means of said switching elements the two phase lines are each able to be connected to said first output of said modular matrix converter.

2. The converter arrangement according to claim 1, wherein
said modular matrix converter has outputs including said first output, a second output and a third output; and
said precharging device further has a changeover device, by means of said changeover device said first output of said modular matrix converter is able to be connected to said second output and said third output of said module matrix converter.

3. The converter arrangement according to claim 1, wherein:
said modular matrix converter has outputs including said first output and a second output;
said at least one precharging module is a first precharging module of a plurality of precharging modules; and
said plurality of precharging modules further includes a second precharging module connected on the grid side to exactly two of the phase lines of the three-phase AC voltage connection and on the load side to said second output of said modular matrix converter, and said second precharging module contains switching elements, by means of said switching elements of said second precharging module the two phase lines are each able to be connected to said second output of said modular matrix converter.

4. The converter arrangement according to claim 1, wherein said at least one precharging module, comprises:
a first precharging branch configured for connecting a first phase line of the three-phase AC voltage connection to said first output of said modular matrix converter, and having a first switch element; and
a second precharging branch configured for connecting a second phase line of the three-phase AC voltage connection to said first output of said modular matrix converter, and having a second switching element.

5. The converter arrangement according to claim 1, wherein at least one of said switching elements of said at least one precharging module is a circuit breaker.

6. The converter arrangement according to claim 1, wherein at least one of said switching elements of said at least one precharging module is a disconnect switch.

7. The converter arrangement according to claim 1, wherein said at least one precharging module has resistors for peak current limitation.

8. The converter arrangement according to claim 7, wherein one of said resistors is connected in series with each of said switching elements of said at least one precharging module.

9. The converter arrangement according to claim 7, wherein said resistors each have a resistance value of 10 ohms to 100 ohms.

10. The converter arrangement according to claim 1, wherein said precharging device further has a precharging resistor circuit, wherein said precharging resistor circuit has resistors which are each disposed in one phase line of the three-phase AC voltage connection and are able to be bridged by means of at least one bridging switch.

11. The converter arrangement according to claim 1, wherein said modular matrix converter has:
outputs including said first output; and
a plurality of converters, wherein said converters each have a plurality of main modules, wherein said main modules each have an input connection which is connected in each case to one phase line of the three-phase AC voltage connection and an output connection, wherein said converters each have a star point which is connected on a first side to said output connection of said main modules of said converters and on a second side to one of said outputs of said modular matrix converter, wherein said main modules each have a series connection of a coupling inductance and of a plurality of said switching modules.

12. The converter arrangement according to claim 11, wherein a number of said switching modules in each of said main modules is between 10 and 100.

13. The converter arrangement according to claim 1, further comprising input connections and output connections, wherein a first operating frequency at one of said input connections of the converter arrangement is lower than a second operating frequency at one of said output connections of the converter arrangement.

14. The converter arrangement according to claim 1, further comprising:
a first connecting device disposed on an input side of said modular matrix converter; and/or
a second connecting device disposed on an output side of said modular matrix converter.

15. A method for operating a converter arrangement having a modular matrix converter, wherein the modular matrix converter having switching modules which each have power semiconductor switches and an energy store belonging to each of the switching modules, and the switching modules being connected on a grid side to an at least three-phase AC voltage connection, the modular matrix converter further having a precharging device for precharging energy stores, wherein the precharging device containing at least one precharging module which is connected on the grid side to exactly two phase lines of the at least three-phase AC voltage connection and on a load side to a first output of the modular matrix converter, and the at least one precharing module having switches, by means of the switches the two phase lines are each able to be connected to the first output of the modular matrix converter, which comprises the step of:
connecting the modular matrix converter on the load side sequentially to two of the phase lines of the AC voltage connection by means of the precharging device in order to precharge the energy stores.
